(19) United States
(12) Patent Application Publication
(10) Pub. No.: US 2018/0286001 A1
(43) Pub. Date: Oct. 4, 2018

(54) AUTOMATIC ASSIGNING METHOD AND SYSTEM OF PERIODIC INSPECTION SCHEDULE

(71) Applicant: NIPPON GAS CO., LTD., Tokyo (JP)

(72) Inventors: Shinji WADA, Tokyo (JP); Shingo DEKAMO, Tokyo (JP)

(21) Appl. No.: 15/744,001

(22) PCT Filed: Dec. 22, 2016
(86) PCT No.: PCT/JP2016/088466

§ 371 Date: Jan. 11, 2018

(30) Foreign Application Priority Data
Dec. 25, 2015 (JP) 2015-253940
Nov. 9, 2016 (JP) 2016-218940

(51) Int. Cl. G06Q 50/26; G06Q 10/06; G06Q 10/10; G06Q 50/06

(52) U.S. Cl. CPC G06Q 50/265; G06Q 10/06316; G06F 7/08; G06Q 50/06; G06Q 10/1097

(57) ABSTRACT

Scheduled inspection dates on which safety inspection operations are carried out are scheduled by the respective inspector. Thus, these dates may be scheduled among the respective inspectors in an ineffective and unbalanced manner. A method and a system are provided by which the safety inspection operations are scheduled and inspection target customers can be automatically allocated to the respective inspectors.

### TECHNICAL FIELD

The present invention relates to automatic allocation method and system for a periodic inspection schedule. More particularly, the invention relates to a method and a system by which the safety inspection operations (e.g., the inspection operations of gas supply facilities and consumption facilities) are scheduled to automatically allocate customers as an inspection target to the respective inspectors.

### BACKGROUND ART

Gas, which is one of our lifelines, is supplied in the forms of city gas and liquefied petroleum (LP) gas to customers (customers) such as the respective homes, stores, and business offices for example. The city gas mainly includes natural gas (methane) as a main component. About 97% of the raw material of the city gas is currently occupied by natural gas. This natural gas is stored in a giant gas holder. Thereafter, the city gas in the form of gas is directly supplied to the respective customers via gas meters through pipelines buried under roads. A range from a gas holder to a gas cock is called a gas facility. The management responsibility of the gas facility is generally taken by a gas supplier with regard to the check and the maintenance (a range from the outlet of the gas cock to the gas instruments of the respective customers on the other hand is called a gas consumption device for which the management responsibility is generally taken by the customers). On the other hand, the LP gas includes propane and butane as main components. The LP gas being in the compressed and liquefied form is filled in a gas cylinder for example and is distributed. The gas cylinder is placed at each customer. By gasifying the LP gas in the gas cylinder at an ordinary temperature, gas is supplied via the gas meter (general supply form). The LP gas is supplied in various forms such as a general supply form, a concentric gas supply form, and a community gas supply form. They are supply forms for a multiple-unit residential building for example that has a plurality of customers as a supply destination to the supply facility. Specifically, the LP gas is filed in a gas bulk storage tank placed in the vicinity of the multiple-unit residential building. Thereafter, the LP gas is supplied to the respective customers via the gas meter. The difference between the concentric gas supply and the community gas supply is the quantity of the supply destinations (customers). Customers less than 70 are handled by the concentric gas supply while customers of 70 or more are handled by the community gas supply. In the case of the LP gas, a range from the gas cylinder or the gas bulk for example to the gas meter outlet is called a supply facility. The term “supply facility” is originally used for the case of the LP gas. However, for convenience, the supply facility may be used to also include gas facilities for the city gas. The terms “gas holder”, “gas cylinder”, and “gas bulk” may be collectively referred to as a “gas container”.

The city gas and the LP gas may cause pollution because of the gas leakage or explosion for example. Therefore, Japan has acts having main purposes of providing the safety against pollution, the prevention of pollution, and the appropriate gas transaction (Act Concerning the Securing of Safety and the Optimization of Transaction of Liquefied Petroleum Gas (hereinafter referred to as “LP Act”), Gas Business Act (hereinafter referred to as “GB Act”), and High Pressure Gas Safety Act). These acts require gas suppliers to carry out the periodic inspection on the supply facilities and consumption facilities of the city gas and LP gas (e.g., the LP Act requires the periodic inspection once every four years and the GB Act requires the periodic inspection once every 40 months). This inspection also performs the periodic exchange on components such as a gas alarm unit, a gas meter, an adjuster, or a gas hose. The periodic exchange also performs the management and operation together with the periodic inspection. The periodic exchange also must be carried out not only on the gas facility but also on a fire-fighting facility, an electric facility, and a construction facility for example.

The related terms “inspection”, “check”, and “survey” also may be used differently herein. The term “inspection” means the investigation to cover a consumption facility in the home of the customer. The term “check” means the investigation of the supply facility only. The term “survey” has a similar meaning as that of the term “check” and means the more-detailed investigation of the supply facility. The term “inspection”, “check”, and “survey” also may collectively mean “inspection”. The inspection operation and the component exchange operation are collectively referred to as a safety inspection operation.

Currently, based on a due date list that is a list of the due dates showing the inspection deadlines of the respective facilities, the scheduled inspection dates of the next month inspections are temporarily determined on a predetermined date of the previous month (e.g., on the 15th day) to thereby prepare a schedule list. The inspector reports the temporarily-determined scheduled inspection date to a manager. When the scheduled inspection date is fixed, then the date is notified to the customer by a postcard. Thereafter, the customer may send a request for a change of the date. In this case, the date is negotiated among the respective inspectors to thereby change the scheduled inspection date. When the customer is absent, then the scheduled inspection date is rescheduled. The temporarily-determined scheduled inspection date is fixed at the end of the month and the schedule list of the respective inspectors is updated with the fixed contents.

However, the scheduling process (including the rescheduling process) of the scheduled inspection date is performed by the respective inspectors and thus is insufficient. Furthermore, there may be a case where the scheduling process is carried out among the respective inspectors in an unbalanced manner (e.g., a certain inspector travels a long distance or has a large amount of operation). Furthermore, allowing the inspector to perform the rescheduling process is not appropriate because this process involves a management business. On the other hand, the due date list is prepared by the manager whenever the need arises, which is also insufficient. Due to the above situation, a method and a system are required by which the safety inspection operation is scheduled to automatically allocate customers as an inspection target to the respective inspectors.

When the scheduled inspection date is temporarily determined and subsequently the contract with a customer as an inspection target is cancelled or the delinquency of a gas bill is found for example, then the customer as an inspection target has a cock-closed status (a gas supply-stopped status). In the case of the cock-closed status, no gas is used, thus resulting in no inspection regardless of the due date (and an inspection will be carried out when the cock is opened). Therefore, the target customer must be deleted from the schedule list. Furthermore, when a customer has a delinquency of a gas bill for example, then the customer is be deleted from the schedule list and subsequently the gas bill is paid by a money transfer. In this case, there may be a case where the cock-closed status is followed by a cock-opened status again, requiring an inspection. In this case, the operation to delete the target customer from the schedule list must be reset and the target customer must be included in the schedule list. Currently, such an adjustment of the schedule list is not performed. Thus, there may be a case where the inspector knows that no inspection is required on the scheduled inspection date, causing an unnecessary labor.

### SUMMARY OF THE INVENTION

In order to achieve the objective as described above, the present invention provides a computer for allocating customers in a safety inspection operation to inspectors, the computer comprising a processor and a memory, wherein the processor comprises:

a unit of extracting customer data for which an inspection due date or a re-inspection due date is within a predetermined period and a specific area is related, from customer data stored in the memory including at least, the inspection due date showing a legal inspection deadline of an inspection target facility, the re-inspection due date showing a legal inspection deadline when a re-inspection of the inspection target facility is required, and a postal code, regarding the customer, wherein the specific area includes a plurality of areas shown by a plurality of the postal codes;

a unit of extracting inspector data of the specific area, from inspector data stored in the memory including at least an allocation priority order;

a unit of sorting the extracted customer data at least in an order of the postal codes; and

a unit of allocating the sorted customer data in an order of an inspector for which the priority order is high.

In the computer according to the previous paragraph, the processor further comprises:

a unit of preparing, based on the result of allocating the sorted customer data, scheduled inspection data including at least the customer, scheduled inspection date, and responsible inspectors;

a unit of preparing, based on the scheduled inspection data, scheduled inspection notification data including at least an address and a full name of the customer, the scheduled inspection date, an inspection time period, and a name and contact information of a company responsible for an inspection;

a unit of sending, when a dispatch of a postcard to the customer is requested to a printing company, the scheduled inspection notification data or postcard printing data prepared based on the scheduled inspection notification data to a computer of the printing company; and

a unit of printing, when the dispatch of the postcard to the customer is not requested to the printing company, the postcard based on the scheduled inspection notification data.

In the computer according to the previous paragraph, the scheduled inspection data is data for a scheduled inspection date in or after the next month, and

the sorting includes putting the first priority on sorting data for which the inspection due date or the re-inspection due date is in or before the next month.

In the computer according to any of the two previous paragraphs, the customer data further includes a cock type showing a gas cock-opened status and a gas cock-closed status, the extracting the customer data further comprises extracting only data for which the cock type shows the cock-opened status, and the processor further comprises:

a unit of receiving a cock close notification showing that the customer will be in the cock-closed status;

a unit of determining, in response to receiving the cock close notification, whether or not the prepared scheduled inspection data includes data for a customer who will be in the cock-closed status; and

a unit of setting, when the prepared scheduled inspection data includes the data for a customer who will be in the cock-closed status, the data to a deleted status.

In the computer according to any of the four previous paragraphs, the allocating includes sequentially allocating the sorted customer data to an inspector for which the priority order is high based on at least one of predetermined operation time period, required inspection time, allocation margin, and the non-work days and eligibility of the inspector.

Furthermore, in the computer according to the previous paragraph, the processor further comprises:

a unit of receiving a cock open notification showing that the customer will be in a cock-opened status; and

a unit of resetting, in response to receiving the cock open notification, the deleted status of the data for a customer who will be in the cock-opened status among the scheduled inspection data.

The present invention also provides, in another embodiment, a method performed by a computer for allocating customers in a safety inspection operation to inspectors, wherein the computer comprises a processor and a memory, the method comprising:

extracting, by the processor, customer data for which an inspection due date or the re-inspection due date is within a predetermined period and a specific area is related, from customer data stored in the memory including at least, the inspection due date showing a legal inspection deadline of an inspection target facility, the re-inspection due date showing a legal inspection deadline when a re-inspection of the inspection target facility is required, and a postal code, regarding the customer, wherein the specific area includes a plurality of areas shown by a plurality of the postal codes;

extracting, by the processor, inspector data of the specific area from inspector data stored in the memory including at least an allocation priority order;

sorting, by the processor, the extracted customer data at least in an order of the postal codes; and

allocating, by the processor, the sorted customer data in an order of an inspector for which the priority order is high.

Furthermore, the present invention provides, in still another embodiment, a computer-readable storage medium storing therein a computer-executable instruction for causing a computer to perform a method of allocating customers in a safety inspection operation to inspectors, the computer comprises a processor and a memory, the method comprising:

extracting, by the processor, customer data for which an inspection due date or the re-inspection due date is within a predetermined period and a specific area is related, from customer data stored in the memory including at least, the inspection due date showing a legal inspection deadline of an inspection target facility, the re-inspection due date showing a legal inspection deadline when a re-inspection of the inspection target facility is required, and a postal code, regarding the customer, wherein the specific area includes a plurality of areas shown by a plurality of the postal codes;

extracting, by the processor, inspector data of the specific area from inspector data stored in the memory including at least an allocation priority order;

sorting, by the processor, the extracted customer data at least in an order of the postal codes; and

allocating, by the processor, the sorted customer data in an order of an inspector for which the priority order is high.

### EFFECT OF THE INVENTION

As described above, according to the present invention, the safety inspection operation can be scheduled to automatically allocate customers as an inspection target to the respective inspectors. The scheduled inspection data (schedule list) prepared by the automatic allocation can be communicated to a printing company to notify the customers of the scheduled inspections. In addition, the automatically-allocated scheduled inspection also can be readjusted. Furthermore, when a customer as an inspection target is in a cock-closed status, the target customer can be deleted from the scheduled inspection data. When the customer in the cock-closed status is set to the cock-opened status again, then the target customer can be included again in the scheduled inspection data.

### BRIEF DESCRIPTION OF THE DRAWINGS

FIG. 1 illustrates the system configuration according to one embodiment of the present invention;

FIG. 2 is a flow diagram illustrating a series of processing of the automatic allocation according to one embodiment of the present invention;

FIG. 3 is a flow diagram illustrating the details of the automatic allocation processing according to one embodiment of the present invention;

FIG. 4 illustrates data stored in a customer data storage unit according to one embodiment of the present invention;

FIG. 5 illustrates data stored in a safety inspection area data storage unit according to one embodiment of the present invention;

FIG. 6 illustrates data stored in a postal code mapping data storage unit according to one embodiment of the present invention;

FIG. 7 illustrates data stored in an inspector data storage unit according to one embodiment of the present invention;

FIG. 8 illustrates data stored in an inspector non-work day data storage unit according to one embodiment of the present invention;

FIG. 9 illustrates data stored in a scheduled inspection data storage unit according to one embodiment of the present invention;

FIG. 10 illustrates data stored in a scheduled inspection notification data storage unit according to one embodiment of the present invention;

FIG. 11 is a flow diagram illustrating a series of processing to delete the scheduled inspection data according to one embodiment of the present invention; and

FIG. 12 is a flow diagram illustrating a series of processing to reset the deleted scheduled inspection data according to one embodiment of the present invention.

### DESCRIPTION OF EMBODIMENTS

The following section will describe a method and a system according to an embodiment of the present invention according to the attached drawings.

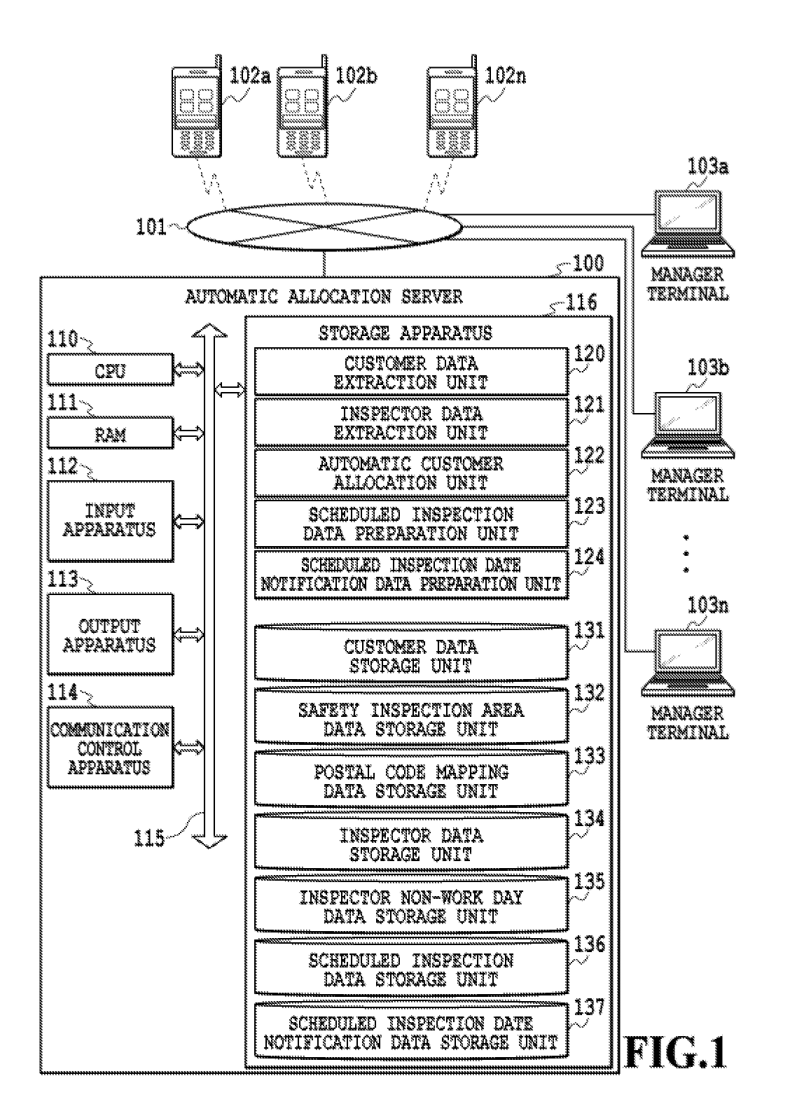

FIG. 1 illustrates a system configuration according to one embodiment of the present invention. In FIG. 1, an automatic allocation server 100 provided in a data center for example is configured to communicate, via a network 101, with a plurality of mobile terminals 102a, 102b, . . . , 102n (hereinafter referred to as “the mobile terminal 102”) and a plurality of manager terminals 103a, 103b, . . . , 103n (hereinafter referred to as “the manager terminal 103”).

The automatic allocation server 100 allocates, for each safety inspection area, customers as an inspection target to responsible inspectors and prepares scheduled inspection data. The automatic allocation server 100 prepares, based on the scheduled inspection data, postcard data for the notification to customers (e.g., PDF file). The automatic allocation server 100 sends the prepared postcard data to a printing company server (not shown), thereby requesting the printing company to print and dispatch postcards. The automatic allocation server 100 receives prepared postcard data from the printing company server. Thereafter, the automatic allocation server 100 prints postcards based on the postcard data. The printed postcards are dispatched to the respective customers. The automatic allocation server 100 receives a request to adjust the scheduled inspection date from a mobile terminal 102 or a manager terminal 103. The automatic allocation server 100 determines whether or not the adjustment is possible based on the received request. If the adjustment based on the received request is possible, then the automatic allocation server 100 updates the scheduled inspection data.

The mobile terminal 102 is carried by an inspector who performs the safety inspection operation. The mobile terminal 102 receives the scheduled inspection data from the automatic allocation server 100. The inspector performs the safety inspection based on the scheduled inspection data. If the inspector is absent for example, the scheduled inspection can be readjusted via the mobile terminal 102.

The manager terminal 103 is provided at each business transaction base or a call center for example. The manager terminal 103 also receives the scheduled inspection data from the automatic allocation server 100. A manager or a responsible person of a call center can readjust the scheduled inspection via the manager terminal 103 when receiving a request from a customer for a change of the scheduled date for example.

Next, the following section will describe in detail the configuration of the automatic allocation server 100. The automatic allocation server 100 has a configuration in which a CPU (processor) 110 is connected, via a system bus 115, to a storage apparatus 116 configured by an RAM (memory) 111, an input apparatus 112, an output apparatus 113, the communication control apparatus 114, and a nonvolatile storage medium (e.g., ROM or HDD). The storage apparatus 116 includes a program storage region storing a software program related to the automatic allocation processing and a data storage region storing related data for example. The respective units of the program storage region described hereinafter are actually an independent software program and the routine and component thereof for example. The CPU 110 causes the units to be called by the storage apparatus 116. The units are developed into the work area of the RAM 111 and are sequentially executed, thereby providing the respective functions.

The software programs stored in the program storage region that are related to the present invention include a customer data extraction unit 120, an inspector data extraction unit 121, an automatic customer allocation unit 122, a scheduled inspection data preparation unit 123, and a scheduled inspection date notification data preparation unit 124.

The customer data extraction unit 120 extracts, from a customer data storage unit 131, data related to the inspection target customer that satisfies predetermined conditions (e.g., within a due date upper limit or in the cock-opened status). The wording “within a due date upper limit” means a status in which an inspection deadline specified by an act (due date) is within a predetermined period.

The inspector data extraction unit 121 extracts, from an inspector data storage unit 134, data for an inspector responsible for a safety inspection area of an allocation target.

The automatic customer allocation unit 122 allocates an inspection target customer to the responsible inspector. When the automatic customer allocation unit 122 receives a request to adjust the scheduled inspection from the mobile terminal 102 or the manager terminal 103, the automatic customer allocation unit 122 determines whether or not the adjustment is possible based on the received request. If adjustment based on the request is possible, the automatic customer allocation unit 122 performs the reallocation.

Based on automatic allocation result, the scheduled inspection data preparation unit 123 prepares scheduled inspection data and stores the scheduled inspection data in a scheduled inspection data storage unit 136. Based on the reallocation result, the scheduled inspection data preparation unit 123 updates the scheduled inspection data.

Based on the scheduled inspection data, the scheduled inspection date notification data preparation unit 124 prepares scheduled inspection date notification data and stores the scheduled inspection date notification data in a scheduled inspection date notification data storage unit 137. The scheduled inspection date notification data preparation unit 124 sends the prepared scheduled inspection date notification data to a printing company server, thereby requesting the printing company to print and dispatch postcards. In another embodiment, the scheduled inspection date notification data preparation unit 124 also can prepare postcard data (e.g., PDF file) based on the prepared scheduled inspection date notification data to send the postcard data to the printing company server.

The data storage region includes regions related to the present invention such as the customer data storage unit 131, a safety inspection area data storage unit 132, a postal code mapping data storage unit 133, the inspector data storage unit 134, an inspector non-work day data storage unit 135, the scheduled inspection data storage unit 136, and the scheduled inspection date notification data storage unit 137 any of which is a fixed storage region secured in the storage apparatus 116.

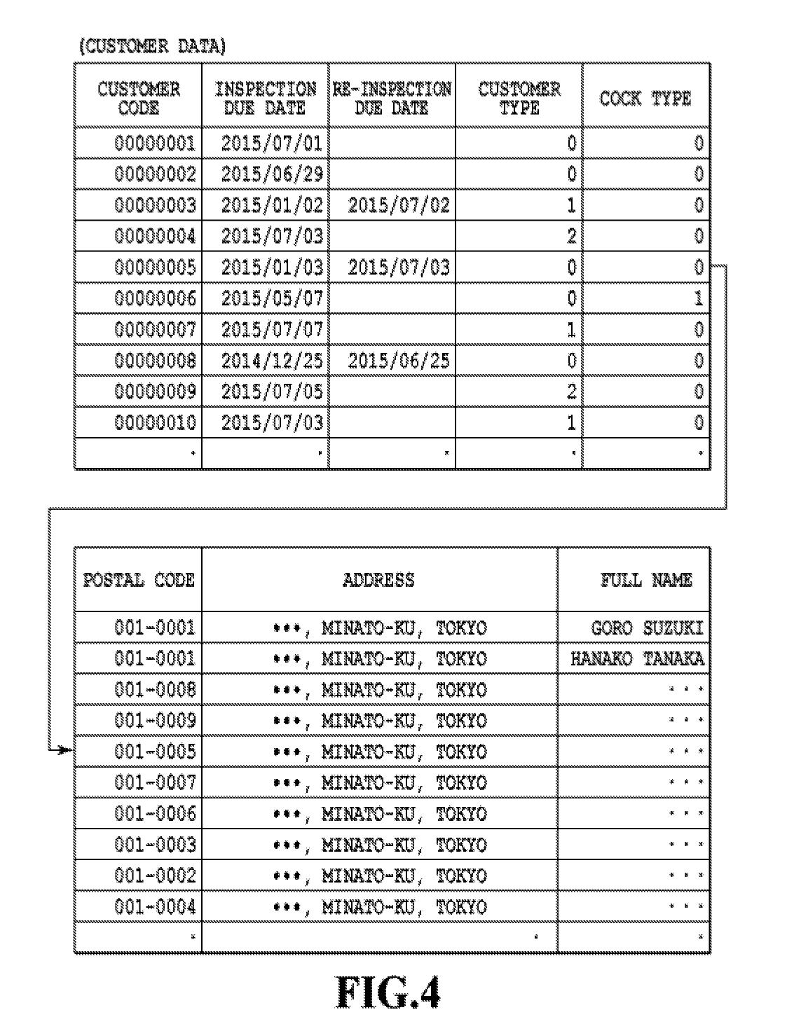

The customer data storage unit 131 stores therein data for a safety inspection target. FIG. 4 illustrates data stored in the customer data storage unit 131 according to one embodiment of the present invention. In FIG. 4, the customer data includes the “customer code” uniquely showing a customer, the “inspection due date” for the customer showing a legal inspection deadline of an inspection target facility, the “re-inspection due date” showing a legal inspection deadline when the re-inspection is required, the “customer type” showing the type of an act specified for the inspection target facility of the customer, the “cock type” showing the gas cock-opened status or the gas cock-closed status, the “postal code” showing the postal code of the customer home, the “address” showing the address of the customer home, and the “full name” showing the full name of the customer. The “re-inspection” means an inspection that is resumed, when an inappropriate inspection is performed by the inspection due date, after a stipulated period (i.e., after a re-inspection due date) following the request for the correction by the inspector to the customer. Thus, the “re-inspection due date” is stored only when the re-inspection is required. The wording “within the due date upper limit” when the “re-inspection due date” is set means a status in which the “re-inspection due date” is within the predetermined period. The wording “within the due date upper limit” when the “re-inspection due date” is not set on the other hand means a status in which the “inspection due date” is within the predetermined period. Regarding the term “customer type”, when an act stipulated to the inspection target facility for example is the LP Act, the customer type can be set to “0” and, when an act stipulated to the inspection target facility for example is the GB Act, the customer type can be set to “1” and, when an act stipulated to the inspection target facility for example is the High Pressure Gas Safety Act, then the customer type can be set to “2”. The “cock type” can be set to “0” when the cock is in the cock-opened status and can be set to “1” when the cock is in the cock-closed status.

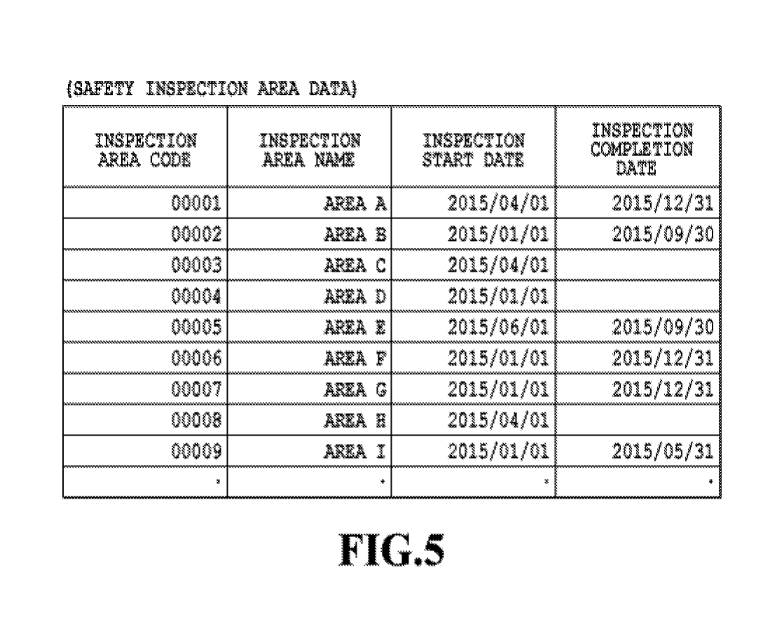

The safety inspection area data storage unit 132 stores therein data for an area in which the safety inspection is performed. FIG. 5 illustrates data stored in the safety inspection area data storage unit 132 according to one embodiment of the present invention. In FIG. 5, the safety inspection area data includes the “inspection area code” uniquely showing the area as a safety inspection target, the “inspection area name” showing the name of the inspection area, the “inspection start date” showing the start date of a period within which the inspection of the inspection area is required, and the “inspection completion date” showing the completion date of the period.

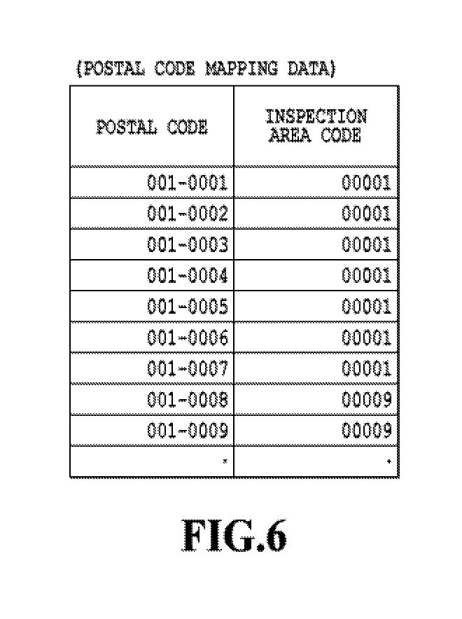

The postal code mapping data storage unit 133 stores therein data for mapping the safety inspection areas and postal codes. FIG. 6 illustrates data stored in the postal code mapping data storage unit 133 according to one embodiment of the present invention. In FIG. 6, the postal code mapping data includes the “postal code” showing the postal codes of customers, and the “inspection area codes” mapped to the postal codes. In FIG. 6, one inspection area includes areas of a plurality of postal codes.

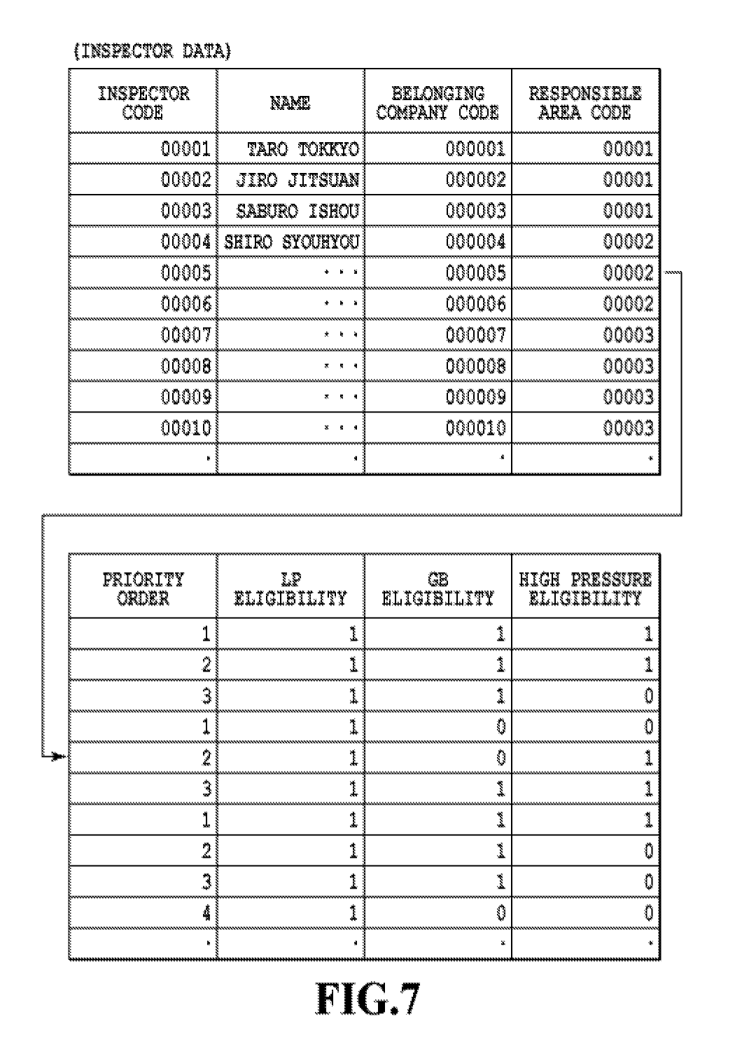

The inspector data storage unit 134 stores therein data for inspectors performing the safety inspection operation. FIG. 7 illustrates data stored in the inspector data storage unit 134 according to one embodiment of the present invention. In FIG. 7, the inspector data includes the “inspector codes” uniquely showing the inspectors, the “names” showing the full names of the inspectors, the “belonging company codes” uniquely showing the companies to which the inspectors belong, the “responsible area codes” uniquely showing inspection areas responsible for the inspectors, the “priority orders” showing the allocation priority order, the “LP eligibility” showing the eligibility for the inspection of a facility stipulated in the LP Act, the “GB eligibility” showing the eligibility for the inspection of a facility stipulated in the GB Act, and the “High Pressure eligibility” showing the eligibility for the inspection of a facility stipulated in the High Pressure Gas Safety Act. The “responsible area code” is associated with the “inspection area code” in the safety inspection area data (FIG. 5). The “priority order” also can be changed for each allocated scheduled inspection date for example in order to handle the inspectors in a fair manner. The “LP eligibility”, “GB eligibility”, and “High Pressure eligibility” can be set to “0” when the inspector is not eligible to perform the inspection of the facility as stipulated in each act and can be set to “1” when the inspector is eligible to perform the inspection of the facility as stipulated in each act.

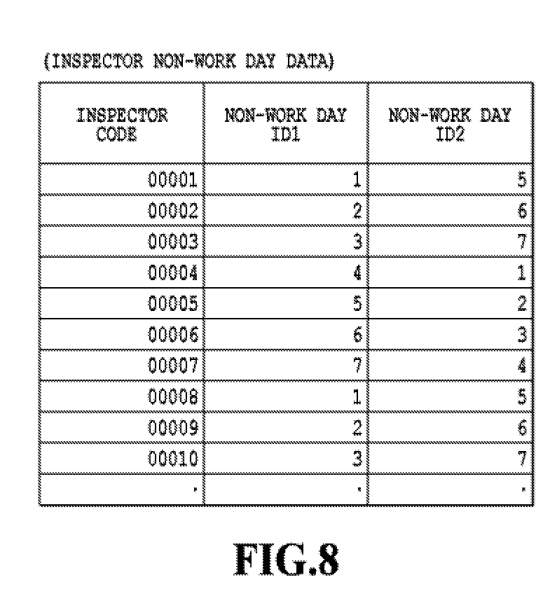

The inspector non-work day data storage unit 135 stores therein data regarding non-work days of inspectors. FIG. 8 illustrates data stored in the inspector non-work day data storage unit 135 according to one embodiment of the present invention. In FIG. 8, the inspector non-work day data includes the “inspector code” uniquely showing the inspector as well as the “non-work day ID1” and “non-work day ID2” uniquely showing days set as non-work days. The “inspector code” is associated with the “inspector code” in the inspector data (FIG. 7). The “non-work day ID1” and “non-work day ID2” can be set by setting days from Sunday to Saturday to “1” to “7” for example. In FIG. 8, the “non-work days ID1” and “non-work days ID2” arranged in two data columns show that there are two non-work days per one week. FIG. 8 is merely one embodiment. For example, non-work days also can be set for the respective dates, not for the respective days. A plurality of non-work days also can be set not in data columns but to one inspector on the basis of a record unit.

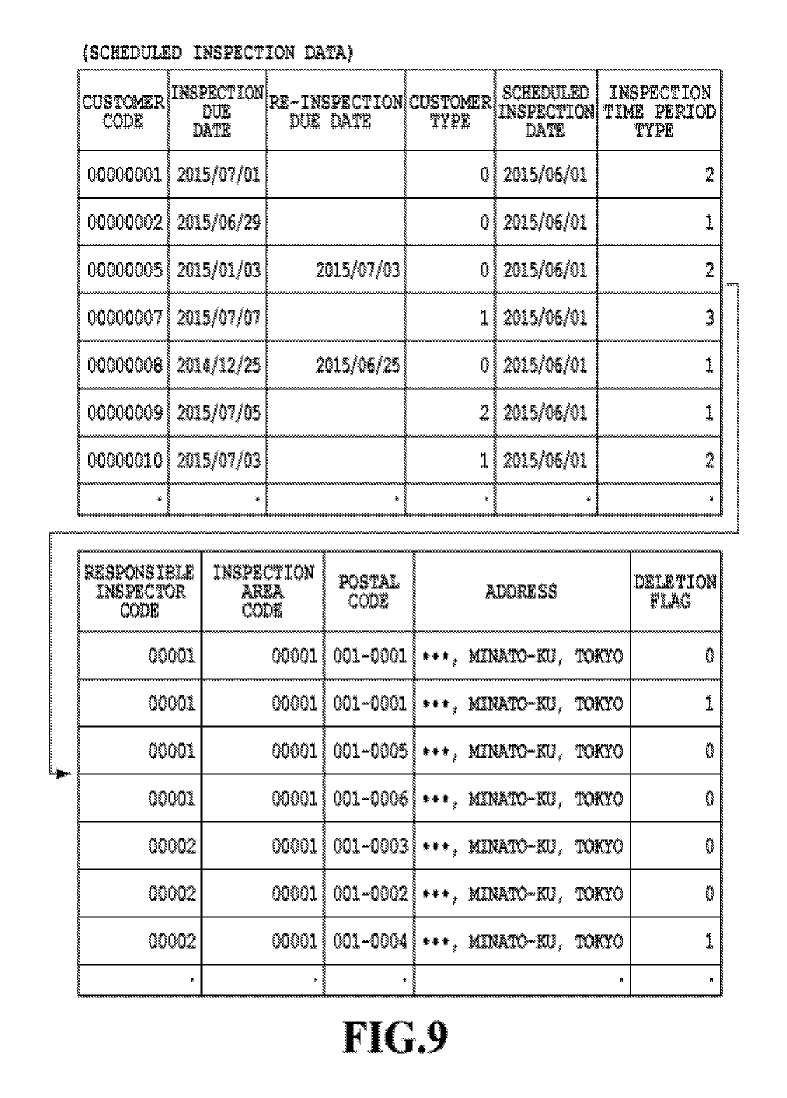

The scheduled inspection data storage unit 136 stores therein data regarding the result of the automatic allocation processing and the schedule of a prepared safety inspection operation. FIG. 9 illustrates data stored in the scheduled inspection data storage unit 136 according to one embodiment of the present invention. In FIG. 9, the scheduled inspection data includes the “customer code” uniquely showing a customer as an inspection target, the “inspection due date” showing a legal inspection deadline of the inspection target facility for the customer, the “re-inspection due date” showing a legal inspection deadline when the re-inspection is required, the “customer type” showing the type of an act specified for the inspection target facility of the customer, the “scheduled inspection date” showing the scheduled inspection date, the “inspection time period type” uniquely showing the time period of the scheduled inspection, the “responsible inspector code” uniquely showing an inspector responsible for the inspection, the “inspection area code” uniquely showing the inspection area including the customer home, the “postal code” showing the postal code of the customer home, the “address” showing the address of the customer home, and the “deletion flag” for logically deleting the data. The above description for the column for the same name for FIG. 4 (customer data) is applied to the “inspection due date”, the “re-inspection due date”, and the “customer type”. The “inspection time period type” can be set to “1” when the scheduled inspection is in the time period from 9 AM to 12 PM, can be set to “2” when the scheduled inspection is in the time period from 1 PM to 4 PM, and can be set to “3” when the scheduled inspection is in the time period from 4 PM to 7 PM for example. The “deletion flag” can be set to “1” when this data is deleted data and is invalid data and can be set to “1” when this data is valid data for example. For example, in one embodiment, there may be a case where customers for the next month inspection are set as a target and this data is prepared on a predetermined date of the previous month (e.g., 15^{th} day). However, there may be a case where this data preparation is followed by the target customer having the cock-closed status and thus no inspection is required or a case where the target customer has the cock-opened status again and thus requires the inspection after the nonexistence of the necessity of the inspection. In this case, if this data is physically deleted, this data must be prepared again, which is undesirable. Thus, a “deletion flag” is used to logically delete the data.

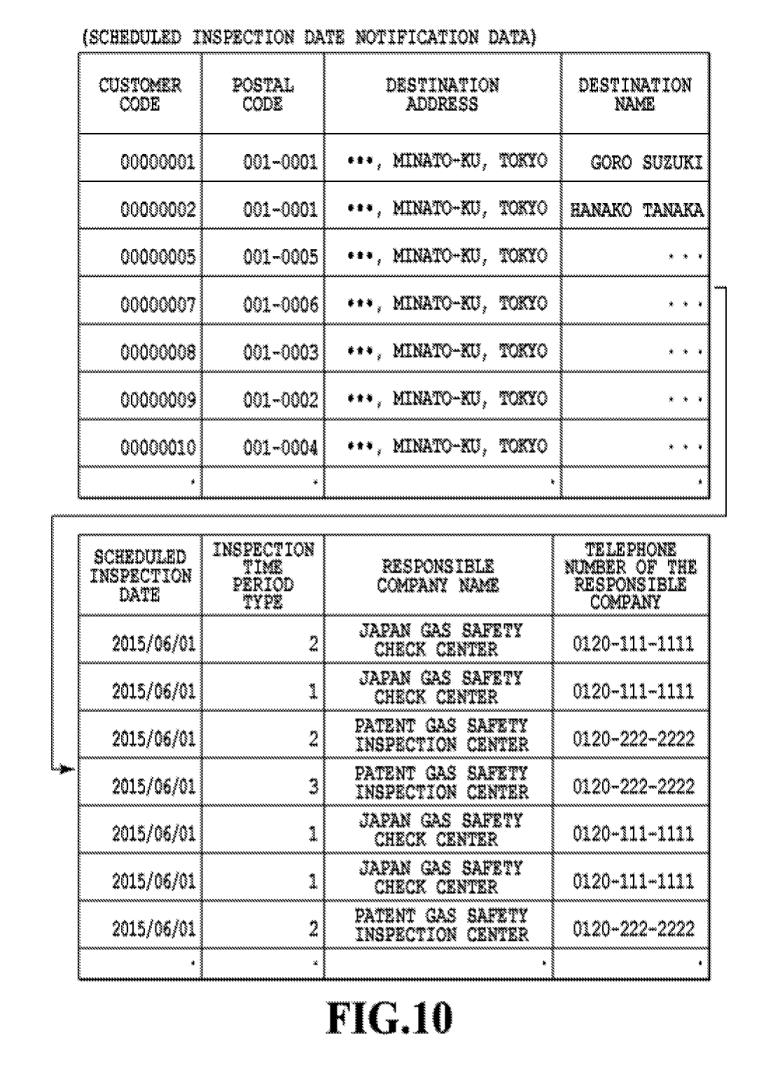

The scheduled inspection date notification data storage unit 137 stores therein data to notify the customer of the scheduled of the safety inspection operation. This scheduled inspection date notification data or postcard data prepared based on this data (e.g., a PDF file) is sent to the printing company server to thereby request the printing company to print and dispatch the postcards. FIG. 10 shows the data stored in the scheduled inspection date notification data storage unit 137 according to one embodiment of the present invention. In FIG. 10, the scheduled inspection date notification data includes the “customer code” uniquely showing the customer to be notified, the “postal code” showing the postal code of the customer, the “destination address” showing the address of the customer, the “destination name” showing the full name of the customer, the “scheduled inspection date” showing the scheduled inspection date, the “inspection time period type” uniquely showing the time period of the scheduled inspection, the “responsible company name” showing the name of a company responsible for the inspection, and the “telephone number of the responsible company” showing the contact information (e.g., a call center) of the company. The above description for the column for the same name for FIG. 9 (scheduled inspection data) is applied to the “inspection time period type”.

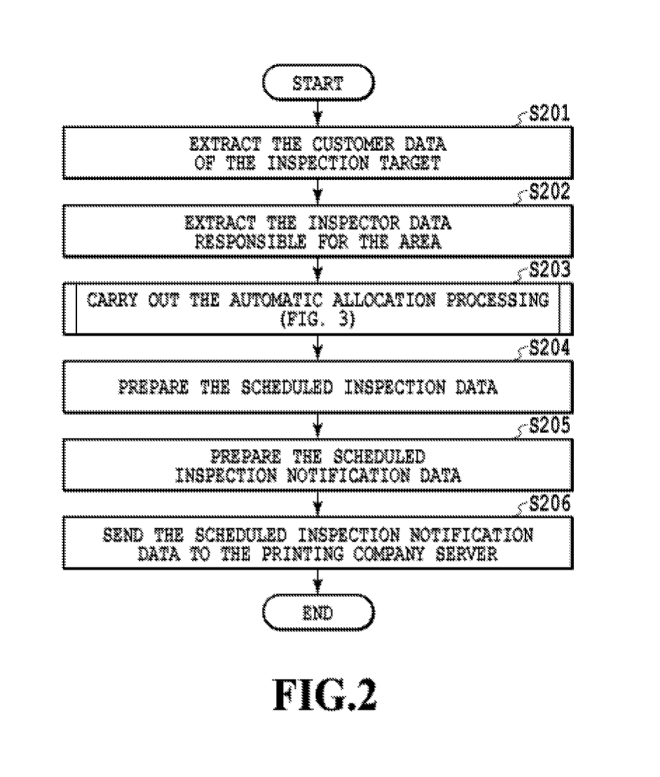

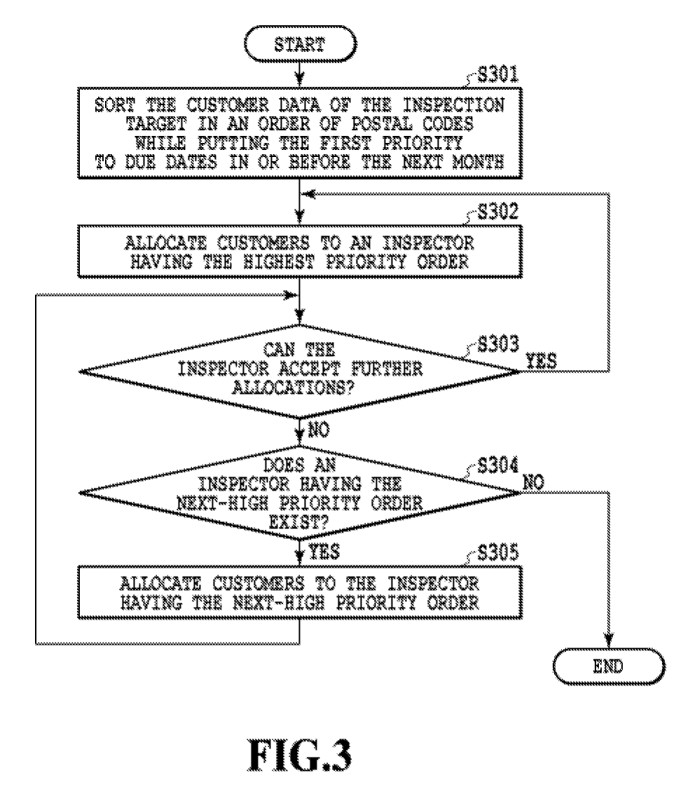

Next, the following section will describe in detail a series of processing of the automatic allocation according to one embodiment with reference to the flowcharts of FIGS. 2 and 3 and the data of FIGS. 4-10.

FIG. 2 is a flow diagram illustrating a series of processing of the automatic allocation according to one embodiment of the present invention. In this embodiment, it is assumed that customers in a certain specific area are automatically allocated to the respective inspectors responsible for the area. This processing is a batch processing that is carried out on the 15^{th} day of every month and that schedules the safety inspection operations in or after the next month for example.

First, in Step 201, the customer data extraction unit 120 extracts, from the customer data storage unit 131, the customer data (FIG. 4) for the inspection target customer matching a predetermined condition. The predetermined condition means, in one embodiment, a customer who is in the specific area, within a due date upper limit, and has the cock-opened status (i.e., a customer for whom the inspection is required and the inspection has a high priority). The due date upper limit is specifically explained as a status in which the “inspection due date” or the “re-inspection due date” in the customer data (FIG. 4) is within the predetermined period (e.g., 3 months from the next month). The cock-opened customer means the “cock type” in the customer data (FIG. 4) is “0” (cock-opened status). In the case of the cock-closed status, the due date is checked during the cock opening process. If this check during the cock opening process shows the necessity of the inspection, then the inspection is carried out, thereby allowing the customer to safely use each facility.

In order to extract the customer data for the specific area, the inspection area code (“00001”) of a specific area (e.g., the area A) is used as a search key to search the postal code mapping data (FIG. 6) stored in the postal code mapping data storage unit 133, thereby acquiring the “postal code” associated with the “inspection area code”. Next, the customer data (FIG. 4) including the acquired “postal code” is extracted. During this, the “inspection area code” also may be used as a search key to search the safety inspection area data (FIG. 5) stored in the safety inspection area data storage unit 132 to determine whether or not the inspection is required for the inspection area (or to determine whether or not the “inspection due date” or the “re-inspection due date” is within a range from the “inspection start date” of the safety inspection area data to the “inspection completion date”). If it is determined that no inspection is required, then this can be notified to the manager terminal 103 for example, thereby completing this processing. Alternatively, the next inspection area also can be subjected to this processing.

Next, the inspector data extraction unit 121 extracts, from the inspector data storage unit 134, the inspector data (FIG. 7) for the inspector responsible for the inspection of the specific area (Step 202). Specifically, the inspection area code (“00001”) of the specific area (area A) set as a target in Step 201 is used as a search key to search the inspector data (FIG. 7) stored in the inspector data storage unit 134 to extract the inspector data having the “responsible area code” matching the inspection area code. For example, in the example of FIG. 7, the data for 3 names having the inspector codes of “00001” to “00003” is extracted as inspectors responsible for the area A. The inspector data extraction of Step 202 and the customer data extraction of Step 201 may be processed to the same area and thus may be processed in different orders or may be processed in a parallel manner.

Next, the automatic customer allocation unit 122 allocates customers to the inspectors having the specific area (area A) set as a target in Steps 201 and 202 (Step 203). The automatic allocation processing of Step 203 will be described in detail using FIG. 3. FIG. 3 is a flow diagram illustrating the details of the automatic allocation processing according to one embodiment of the present invention. FIG. 3 illustrates the processing flow to allocate the customer data of the specific area to the inspectors responsible for the area. FIG. 3 is described so that data corresponding to one certain scheduled inspection date is allocated. Step 202 in FIG. 2 is followed by Step 301 to Step 305 of FIG. 3 as Step 203.

FIG. 3 is a flow diagram illustrating the details of the automatic allocation processing according to one embodiment of the present invention. First, the automatic customer allocation unit 122 sorts the extracted customer data in Step 201 (Step 301). In one embodiment, the sorting is performed by putting the first priority to data having the due date in or before the next month to process the data in an ascending order of the postal code.

Next, the automatic customer allocation unit 122 sequentially allocates the customer data sorted in Step 301 to an inspector having the highest priority order (Step 302). The inspector having the highest priority order is an inspector having the value of the “priority order” of “1” in the inspector data (FIG. 7). In this embodiment, the inspector “Taro Tokkyo” is an inspector having the highest priority order because the inspection target area is set as the area A (area code “00001”).

In one embodiment, the allocation method sets a required time for each customer type in advance to sequentially allocate, from the first day of the scheduled inspection date of the next month, the set required time to the operation time period of each inspector. For example, when the customer type is “0” (LP Act), the required time is 30 minutes and, when the customer type is “1” (GB Act) and “2” (High Pressure Gas Safety Act), then the required time is 40 minutes (the required time may include the time required to travel among customers). The operation time period per day is 9:00-12:00 and 13:00-17:00. Thus, when a customer having the customer type of the LP Act (required time of 30 minutes) is the first allocation target, then this customer is allocated to the period 9:00-9:30 of the inspector “Taro Tokkyo”. When the next customer has the High Pressure Gas Safety Act (required time of 40 minutes), then this customer is allocated to the period 9:30-10:10 of the inspector “Taro Tokkyo”. In this manner, customers are allocated as many as possible to the periods up to 17:00 of the inspector “Taro Tokkyo”. During this, when a customer having the GB Act (required time of 40 minutes) is allocated after customers are already allocated to the periods up to 11:40, then customers also can be allocated to periods including morning and afternoon periods such as 11:40-12:00 and 13:00-13:20. When customers are already allocated to the period up to 16:30 on the other hand, then the remaining time until 17:00 is 30 minutes. Thus, customers having the GB Act and the High Pressure Gas Safety Act (both requiring the time of 40 minutes) cannot be allocated to this period. In this case, an order of allocating customers also can be changed to allocate a customer having the LP Act (required time of 30 minutes) in a prioritized manner.

The allocation margin (allocation rate) also can be used to include a margin in the allocation. For example, when the allocation rate is 85%, customers can be allocated to about 85% of the periods of 9:00-12:00 and 13:00-17:00 (i.e., 9:00-11:30 and 13:00-16:20), respectively. This consequently allows the inspectors to provide an unscheduled operation due to a trouble or an unannounced operation due to a change of the schedule.

The allocation also can be carried out in consideration of the non-work days of inspectors. For example, even when an inspector having the highest priority in Step 302 is “Taro Tokkyo”, if a to-be-allocated scheduled inspection date is a non-work day of the inspector, then this inspector also can be excluded from allocation targets (and an inspector having the second priority “Jiro Jitsuan” is subjected to the determination to determine whether the inspector can accept the allocation or not). The non-work day of the inspector can be determined by using the inspector code as a search key to search the inspector non-work day data storage unit 135 to extract the inspector non-work day data (FIG. 8).

The allocation also can be carried out in consideration of the eligibility situation of inspectors. The reason is that a facility as an inspection target is covered by a different act and a different inspector having a different eligibility can inspect a different facility. The nonexistence of the eligibility is set to “0” and the existence of the eligibility is set to “1” as shown by the “LP eligibility”, “GB eligibility”, and “High Pressure eligibility” in the inspector data (FIG. 7). Thus, in Step 302, even when an inspector having the highest priority is “Taro Tokkyo”, if this inspector does not have the customer type of the to-be-allocated customer (0:LP Act, 1:GB Act, 2: High Pressure Gas Safety Act), then this inspector is excluded from the allocation targets (in this case, an inspector having the second priority “Jiro Jitsuan” is subjected to the determination to determine whether the inspector can accept the allocation or not).

Whenever the allocation of Step 302 is performed, the automatic customer allocation unit 122 determines whether or not the inspector having already accepted the allocation can further accept the allocation (Step 303). This is to determine whether or not the allocation is completed for the above-described inspector having the highest priority “Taro Tokkyo” up to the period to 17:00. If the inspector having already accepted the allocation can further accept the allocation, then the processing proceeds to the Yes route and this inspector is subjected to the allocation of the next customer data (Step 302).

If the inspector having already accepted the allocation cannot accept the allocation any more on the other hand, then the processing proceeds to the No route of Step 303 to allow the automatic customer allocation unit 122 to determine whether or not an inspector having the second priority order exists (Step 304). For example, if inspector having the highest priority “Taro Tokkyo” already fully accepts the allocation, then an inspector having the second priority is “Jiro Jitsuan” (for which the priority order of the responsible area code “00001” in the inspector data of FIG. 7 is the second order). Next, when an inspector having the second priority order exists, the processing proceeds to the Yes route to allow the automatic customer allocation unit 122 to allocate a customer to the inspector (Step 305). The allocation method of Step 305 is similar to the allocation method of Step 302. In Step 305, whenever the allocation is performed, the automatic customer allocation unit 122 similarly determines whether or not the inspector having already accepted the allocation can further accept the allocation (Step 303). If the inspector having already accepted the allocation cannot accept the allocation any more, it is determined whether or not an inspector having the next high priority order exists (Step 304). As described above, so long as there is an inspector responsible for the inspection target area, Steps 303-305 are repeated to perform the allocation. When no more to-be-allocated customer data exists any more, although not shown, the processing of FIG. 3 is completed at this timing.

If an inspector having the next high priority order does not exist in Step 304, then the processing proceeds to the No route, thereby completing the processing of FIG. 3. Strictly speaking, the allocation processing to the next scheduled inspection date is performed by repeating the processing of FIG. 3 from Step 301. In order to handle the inspectors in a fair manner, the priority order of the inspector (the “priority order” in the inspector data of FIG. 7) also can be changed for each allocated scheduled operation date. When the repetition of the processing of FIG. 3 results in the completion of the allocation of the scheduled inspection dates corresponding to one period (e.g., the scheduled inspection dates corresponding the next month), then the processing returns to FIG. 2 to carry out Step 204.

Step 204 is carried out after the allocation of all customers as an inspection target in Step 203 (FIG. 3) is completed. In Step 204, the scheduled inspection data preparation unit 123 prepares the scheduled inspection data (FIG. 9) based on the allocation result to store the data in the scheduled inspection data storage unit 136. Specifically, such data is obtained by adding the scheduled inspection dates or the responsible inspectors based on the allocation result for example to customers as an inspection target.

After Step 204, the scheduled inspection date notification data preparation unit 124 prepares the scheduled inspection date notification data (FIG. 10) based on the scheduled inspection data (FIG. 9) to store the data in the scheduled inspection date notification data storage unit 137 (Step 205). The scheduled inspection date notification data (FIG. 10) includes the “destination name”, the “responsible company name”, or the “responsible company telephone” for example that can be acquired from the customer data (FIG. 4) associated with a customer code or the inspection company data (not shown) associated with an inspector code. The processing after Step 205 is a processing to notify the customer of the scheduled inspection date by a postcard for example. In FIG. 2, although the processing after Step 205 are shown as a series of processing after Step 201, the processing may be actually carried out as separate processing. The reason is that the scheduled inspection determined by the allocation processing is temporarily determined so that the respective inspectors or managers for example can confirm the contents after which this determination is set as a final determination.

Next, the scheduled inspection date notification data preparation unit 124 sends the prepared scheduled inspection date notification data (FIG. 10) to the printing company server (Step 206). In another embodiment, the scheduled inspection date notification data preparation unit 124 prepares postcard data (e.g., a PDF file for a postcard printing purpose obtained by burying predetermined data in a postcard format) based on the scheduled inspection date notification data for example and sends the data to the printing company server, thereby requesting the printing company to print and dispatch postcards. The automatic allocation server 100 also can allow the postcards to be printed and dispatched without requesting the printing company to print and dispatch the postcards. Furthermore, when the postcards are to be dispatched to customers on the day on which the printing company receives the scheduled inspection date notification data (or the postcard data) or within a predetermined number of days, the automatic allocation server 100 can adjust the timing at which the scheduled inspection date notification data (or the postcard data) is sent. For example, by allowing the automatic allocation server 100 to have the non-work day data of a printing company in advance, the automatic allocation server 100 also can adjust the transmission timing so that customers can receive postcard at least one week before the scheduled inspection date. After Step 206, this processing is completed.

There may be a case where a customer having received a postcard requests that the specified scheduled inspection date should be adjusted (e.g., a telephone communication may be provided to a call center of the responsible company shown in the postcard). In this case, the inspector, manager or the responsible person of the call center of the responsible company requests, via the mobile terminal 102 or the manager terminal 103, the automatic allocation server 100 to adjust the scheduled inspection date (e.g., to send a changed scheduled date together with the request). Upon receiving the request to adjust the scheduled inspection date from the mobile terminal 102 or the manager terminal 103, the automatic customer allocation unit 122 determines whether or not the adjustment is possible as requested. If it is determined that the adjustment is possible as requested, the automatic customer allocation unit 122 executes the reallocation. The reallocation may be carried out on the same inspector or another inspector so long as customers are reallocated to available operation time periods in the scheduled inspection data allocated to each inspector. Thereafter, each inspector carries out the safety inspection operation based on the contents of the scheduled inspection data.

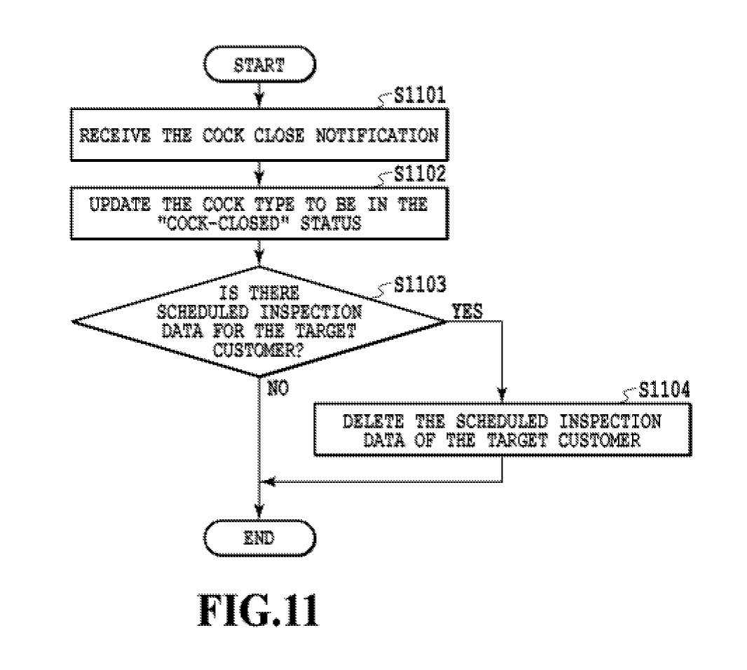

Next, with reference to the flowchart of FIG. 11, the following section will describe in detail a series of processing to delete the scheduled inspection data according to one embodiment. FIG. 11 is a flow diagram illustrating a series of processing to delete the scheduled inspection data according to one embodiment of the present invention. When the preparation of the scheduled inspection data (FIG. 9) is followed by the cancellation of the contract with a customer as an inspection target or the delinquency of a gas bill for example, then the customer as an inspection target is set in the cock-closed status (a status in which the gas supply is stopped). In this case, no inspection is required, thus requiring an operation to delete the prepared scheduled inspection data.

First, in Step 1101, the automatic allocation server 100 receives the cock close notification from the manager terminal 103 for example. This cock close notification is list data including the identifier of the customer for whom the cock will be closed (e.g., a customer code) for example. If there is the cancellation of the contract with a customer or the delinquency of a gas bill for example, the cock close notification is sent to the automatic allocation server 100 in line with these processing or by the manual input by the manager terminal 103.

Upon receiving the cock close notification, the automatic allocation server 100 uses the customer code of the customer for whom the cock is to be closed as a search key to search the customer data (FIG. 4) and sets the “cock type” of the target customer to the “cock-closed status” (“1”) (Step 1102).

Next, the automatic allocation server 100 searches whether or not the target customer has scheduled inspection data (Step 1103). This similarly uses, as in Step 1102, the customer for whom the cock is to be closed as a search key to search the scheduled inspection data (FIG. 9). If the target customer does not have the scheduled inspection data, the processing proceeds to the No route of Step 1103, thereby completing this processing. The processing of Step 1102 and Steps 1103 and 1104 may be carried out in an opposite order but are desirably carried out in one transaction.

If the target customer does not have the scheduled inspection data on the other hand, then the processing proceeds to the Yes route of Step 1103 to allow the automatic allocation server 100 to delete the scheduled inspection data of the target customer (Step 1104). This also can be achieved by physically deleting the record of the target customer in the scheduled inspection data (FIG. 9) or by logically deleting the record. In particular, if a processing to reset the deletion of the data as described below is performed, the data must be logically deleted. If the data is logically deleted, then the “deletion flag” in the scheduled inspection data (FIG. 9) is set to the “deleted status” (or “1”). As a result, the data can be set as invalid data as scheduled inspection data, thereby excluding the target customer from inspection targets. After Step 1104, this processing is completed.

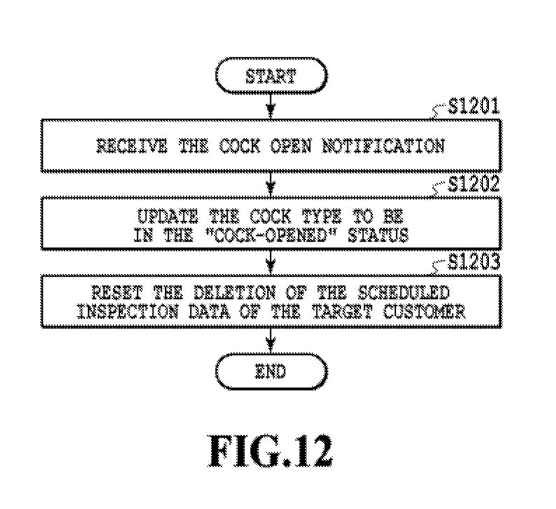

Next, with reference to the flowchart of FIG. 12, the following section will describe in detail a series of processing to reset the deletion of the scheduled inspection data according to one embodiment. FIG. 12 is a flow diagram illustrating a series of processing to delete and reset the scheduled inspection data according to one embodiment. If a gas bill is paid by a money transfer for example after the operation to delete the scheduled inspection data (FIG. 9) is performed, then the inspection target customer is again set in the cock-opened status. In this case, since the inspection is now required, an operation to delete the scheduled inspection data must be reset (i.e., an operation to recover the scheduled inspection data is required).

First, in Step 1201, the automatic allocation server 100 receives the cock open notification from the manager terminal 103 for example. The cock open notification is, as in the case of the cock close notification, list data including the identifier of the customer for whom the cock is to be opened (e.g., a customer code). If a gas bill is paid by a money transfer for example, the cock open notification is sent to the automatic allocation server 100 in line with these processing or by the manual input by the manager terminal 103.

Upon receiving the cock open notification, then the automatic allocation server 100 uses the customer code of the customer for whom the cock is to be opened as a search key to search the customer data (FIG. 4) and sets the “cock type” of the target customer to the “cock-opened status” (“0”) (Step 1202).

Next, the automatic allocation server 100 recovers the scheduled inspection data of the target customer (Step 1203). Specifically, the automatic allocation server 100 sets the “deletion flag” in the scheduled inspection data (FIG. 9) to a “normal status” (or “0”). As a result, the data is valid data as scheduled inspection data and the target customer can be set as an inspection target. After Step 1203, this processing is completed. The processing of Step 1202 and Step 1203 can be performed in an opposite order but are desirably carried out in one transaction.

As described above, the safety inspection operations can be scheduled to automatically allocate inspection target customers to the respective inspectors. The scheduled inspection data (schedule list) prepared by the automatic allocation also can be communicated to the printing company and the customers can be notified of the scheduled inspections. In addition, the automatically-allocated scheduled inspections also can be readjusted. If an inspection target customer is set in the cock-closed status, then the target customer also can be deleted from the scheduled inspection data. If a customer set in the cock-closed status is again set in the cock-opened status, then the target customer can be recovered to be included in the scheduled inspection data.

1. A computer for allocating customers in a safety inspection operation to inspectors, the computer comprising a processor and a memory, wherein the processor comprises:
a unit of extracting customer data for which an inspection due date or a re-inspection due date is within a predetermined period and a specific area is related, from customer data stored in the memory including at least, the inspection due date showing a legal inspection deadline of an inspection target facility, the re-inspection due date showing a legal inspection deadline when a re-inspection of the inspection target facility is required, and a postal code, regarding the customer, wherein the specific area includes a plurality of areas shown by a plurality of the postal codes;
a unit of extracting inspector data of the specific area, from inspector data stored in the memory including at least an allocation priority order;
a unit of sorting the extracted customer data at least in an order of the postal codes; and
a unit of allocating the sorted customer data in an order of an inspector for which the priority order is high.

2. The computer according to claim 1, wherein:
the processor further comprises:
a unit of preparing, based on the result of allocating the sorted customer data, scheduled inspection data including at least the customer, scheduled inspection date, and responsible inspectors;
a unit of preparing, based on the scheduled inspection data, scheduled inspection notification data including at least an address and a full name of the customer, the scheduled inspection date, an inspection time period, and a name and contact information of a company responsible for an inspection;
a unit of sending, when a dispatch of a postcard to the customer is requested to a printing company, the scheduled inspection notification data or postcard printing data prepared based on the scheduled inspection notification data to a computer of the printing company; and
a unit of printing, when the dispatch of the postcard to the customer is not requested to the printing company, the postcard based on the scheduled inspection notification data.

3. The computer according to claim 2, wherein:
the scheduled inspection data is data for a scheduled inspection date in or after the next month, and
the sorting includes putting the first priority on sorting data for which the inspection due date or the re-inspection due date is in or before the next month.

4. The computer according to claim 2, wherein:
the customer data further includes a cock type showing a gas cock-opened status and a gas cock-closed status, the extracting the customer data further comprises extracting only data for which the cock type shows the cock-opened status, and the processor further comprises:
a unit of receiving a cock close notification showing that the customer will be in the cock-closed status;
a unit of determining, in response to receiving the cock close notification, whether or not the prepared scheduled inspection data includes data for a customer who will be in the cock-closed status; and
a unit of setting, when the prepared scheduled inspection data includes the data for a customer who will be in the cock-closed status, the data to a deleted status.

5. The computer according to claim 1, wherein:
the allocating includes sequentially allocating the sorted customer data to an inspector for which the priority order is high based on at least one of predetermined, operation time period, required inspection time, allocation margin, and the non-work days and eligibility of the inspector.

6. The computer according to claim 4, wherein:
the processor further comprises:
a unit of receiving a cock open notification showing that the customer will be in a cock-opened status; and
a unit of resetting, in response to receiving the cock open notification, the deleted status of the data for a customer who will be in the cock-opened status among the scheduled inspection data.

7. A method performed by a computer for allocating customers in a safety inspection operation to inspectors, wherein the computer comprises a processor and a memory, the method comprising:
extracting, by the processor, customer data for which an inspection due date or the re-inspection due date is within a predetermined period and a specific area is related, from customer data stored in the memory including at least, the inspection due date showing a legal inspection deadline of an inspection target facility, the re-inspection due date showing a legal inspection deadline when a re-inspection of the inspection target facility is required, and a postal code, regarding the customer, wherein the specific area includes a plurality of areas shown by a plurality of the postal codes;
extracting, by the processor, inspector data of the specific area from inspector data stored in the memory including at least an allocation priority order;
sorting, by the processor, the extracted customer data at least in an order of the postal codes; and
allocating, by the processor, the sorted customer data in an order of an inspector for which the priority order is high.

8. A non-transitory computer-readable storage medium storing therein a computer-executable instruction for causing a computer to perform a method of allocating customers in a safety inspection operation to inspectors, the computer comprises a processor and a memory, the method comprising:
extracting, by the processor, customer data for which an inspection due date or the re-inspection due date is within a predetermined period and a specific area is related, from customer data stored in the memory including at least, the inspection due date showing a legal inspection deadline of an inspection target facility, the re-inspection due date showing a legal inspection deadline when a re-inspection of the inspection target facility is required, and a postal code, regarding the customer, wherein the specific area includes a plurality of areas shown by a plurality of the postal codes;
extracting, by the processor, inspector data of the specific area from inspector data stored in the memory including at least an allocation priority order;
sorting, by the processor, the extracted customer data at least in an order of the postal codes; and
allocating, by the processor, the sorted customer data in an order of an inspector for which the priority order is high.

9. The computer according to claim 3, wherein:
the customer data further includes a cock type showing a gas cock-opened status and a gas cock-closed status, the extracting the customer data further comprises extracting only data for which the cock type shows the cock-opened status, and the processor further comprises:
a unit of receiving a cock close notification showing that the customer will be in the cock-closed status;
a unit of determining, in response to receiving the cock close notification, whether or not the prepared scheduled inspection data includes data for a customer who will be in the cock-closed status; and
a unit of setting, when the prepared scheduled inspection data includes the data for a customer who will be in the cock-closed status, the data to a deleted status.

10. The computer according to claims 2, wherein:
the allocating includes sequentially allocating the sorted customer data to an inspector for which the priority order is high based on at least one of predetermined, operation time period, required inspection time, allocation margin, and the non-work days and eligibility of the inspector.

11. The computer according to claims 3, wherein:
the allocating includes sequentially allocating the sorted customer data to an inspector for which the priority order is high based on at least one of predetermined, operation time period, required inspection time, allocation margin, and the non-work days and eligibility of the inspector.

12. The computer according to claims 4, wherein:
the allocating includes sequentially allocating the sorted customer data to an inspector for which the priority order is high based on at least one of predetermined, operation time period, required inspection time, allocation margin, and the non-work days and eligibility of the inspector.

13. The computer according to claims 5, wherein:
the allocating includes sequentially allocating the sorted customer data to an inspector for which the priority order is high based on at least one of predetermined, operation time period, required inspection time, allocation margin, and the non-work days and eligibility of the inspector.

14. The computer according to claim 5, wherein:
the processor further comprises:
a unit of receiving a cock open notification showing that the customer will be in a cock-opened status; and
a unit of resetting, in response to receiving the cock open notification, the deleted status of the data for a customer who will be in the cock-opened status among the scheduled inspection data.
